(19) United States
(12) Patent Application Publication
(10) Pub. No.: US 2017/0270095 A1
(43) Pub. Date: Sep. 21, 2017

(54) APPARATUS FOR CREATING CONCEPT DICTIONARY

(71) Applicant: KABUSHIKI KAISHA TOSHIBA, Tokyo (JP)

(72) Inventor: Yumi Ichimura, Abiko Chiba (JP)

(21) Appl. No.: 15/386,931

(22) Filed: Dec. 21, 2016

(30) Foreign Application Priority Data
Mar. 16, 2016 (JP) 2016-052971

(51) Int. Cl. G06F 17/27

(52) U.S. Cl. CPC G06F 17/2735; G06F 17/2785; G06F 17/2795; G06F 17/2755; G06F 17/274

(57) ABSTRACT

According to one embodiment, a concept dictionary creation apparatus includes a task presentation unit, an expression acquisition unit and a concept set generator. The task presentation unit presents a task requesting that a first expression included in a sentence be changed to another expression of an identical concept under an intention of the sentence. The expression acquisition unit acquires a second expression entered in response to the task. The concept set generator generates a concept set based on the intention, the first expression and the second expression.

### CROSS-REFERENCE TO RELATED APPLICATION

This application is based upon and claims the benefit of priority from Japanese Patent Application No. 2016-052971, filed Mar. 16, 2016, the entire contents of which are incorporated herein by reference.

### FIELD

Embodiments described herein relate generally to a concept dictionary creation apparatus.

### BACKGROUND

A conventional command-based interactive system accepts only predetermined commands. In contrast, a voice interactive application for smartphones which is called a personal assistant can accept freely-given spoken utterances. For example, if the user says “It's too loud” when listening to music, the voice interactive system responds to the user's utterance by lowering the volume.

An interactive system accepting freely-given utterances is realized by determining acceptable intentions, collecting variations of utterances corresponding to the intentions, and preparing a model for presuming the intentions. However, it is costly to fully collect variations of utterances corresponding to the intentions.

The variations of utterances are of great variety but can be classified roughly into the following two kinds. One is a variation related to modality and style, and the other is a variation related to vocabulary. Let us consider utterances which may be given when the intention to be expressed is to rent a car of certain type at a car rental office. The sentence “I'd like to rent a six-seater car” and the sentence “Can I rent a six-seater car” differ from each other in sentence portions “I'd like to . . . ” and “Can I . . . ” The two sentences are variations in terms of the modality and style. On the other hand, the sentence “I'd like to rent a six-seater car” and the sentence “I'd like to rent a 4WD car” differ in sentence portions “a six-seater car” and “a 4WD car.” These two sentences are variations in terms of the vocabulary. In order to prepare a model having high performance, it is important to generalize the variations regarding the vocabulary. In other words, the expressions that can be regarded as meaning the same should be generalized by replacing them with the same label or class.

The variations regarding the modality and style are not dependent upon the intention of each individual utterance, and can be generated, for example, as expressions of “request”, expressions of “question” and expressions of “politeness.” With respect to the variations regarding the vocabulary, a general dictionary of related words or a thesaurus can be used, provided that the variations are not dependent on the intentions of individual utterances. As for the variations dependent on the intention of individual utterances, however, the general synonym dictionary or thesaurus is not applicable. For example, “4WD” and “four-wheeled drive” are generally regarded as synonyms, and “4WD” and “six-seater car” cannot be generally regarded as synonyms. Under the intention to “rent a car of certain type at a car rental office, however, both the “4WD” and “six-seater car” are regarded as expressing types of cars.

### BRIEF DESCRIPTION OF THE DRAWINGS

FIG. 1 is a block diagram illustrating a concept dictionary creation apparatus according to the first embodiment.

FIG. 2 is an example of information stored in the concept dictionary database shown in FIG. 1.

FIG. 3 is a flowchart illustrating an example of processing performed by the alternative expression determination unit shown in FIG. 1.

FIG. 4 is a flowchart illustrating another example of processing performed by the alternative expression determination unit shown in FIG. 1.

FIG. 5 is a flowchart illustrating an example of processing performed by the expression pair generator shown in FIG. 1.

FIG. 6 is a flowchart illustrating an example of processing performed by the expression pair combination unit shown in FIG. 1.

FIG. 7 is a flowchart illustrating an example of processing performed in step S603 of FIG. 6.

FIG. 8 is a flowchart illustrating an example of processing performed in the expression pair combination processing shown in step S708 of FIG. 7.

FIG. 9A shows an example of a window in which a sentence is to be entered, and FIG. 9B shows an example of a window in which a sentence is entered.

FIG. 10A shows an example of a window in which a rewording task is presented, and FIGS. 10B and 10C show examples of windows in which answers to the rewording task are entered.

FIG. 11 is a block diagram illustrating a concept dictionary creation apparatus according to the second embodiment.

FIG. 12 is a flowchart illustrating an example of processing performed by the concept set update unit shown in FIG. 11.

FIG. 13 is a flowchart illustrating an example of concept set combination processing performed in step S1206 of FIG. 12.

FIG. 14 is a block diagram illustrating a concept dictionary creation apparatus according to the third embodiment.

FIG. 15 is a flowchart illustrating an example of processing performed by the identical-concept expression candidate presentation unit shown in FIG. 14.

FIG. 16 is a flowchart illustrating an example of processing performed by the expression pair generator shown in FIG. 14.

FIG. 17A shows an example of a window in which an identical-concept expression candidate is presented, and FIG. 17B shows an example of a window in which an answer is entered.

FIG. 18 is an example of information stored in the concept dictionary database shown in FIG. 14.

### DETAILED DESCRIPTION

According to one embodiment, a concept dictionary creation apparatus includes a task presentation unit, an expression acquisition unit and a concept set generator. The task presentation unit presents a task requesting that a first expression included in a sentence be changed to another expression of an identical concept under an intention of the sentence. The expression acquisition unit acquires a second expression entered in response to the task. The concept set generator generates a concept set based on the intention, the first expression and the second expression.

Hereinafter, embodiments will be described with reference to the drawings. In the embodiments set forth below, the same elements will be denoted by the same reference symbols, and redundant descriptions will be omitted where appropriate.

### First Embodiment

FIG. 1 schematically illustrates a concept dictionary creation apparatus 100 according to the first embodiment. As shown in FIG. 1, the concept dictionary creation apparatus 100 includes a sentence acquisition unit 101, an alternative expression determination unit 102, a rewording task presentation unit 103, an expression acquisition unit 104, an expression pair generator 105, an expression pair combination unit 106, a concept set registration unit 107 and a concept dictionary database 108. The concept dictionary creation apparatus 100 may be realized by a computer which reads a program from a storage medium, such as a memory, a magnetic disc or an optical disc and which is controlled by the program. By way of example, the concept dictionary creation apparatus 100 uses cloud sourcing to generate a concept dictionary.

The sentence acquisition unit 101 acquires a sentence to be processed and supplies it to the alternative expression determination unit 102 and the expression pair generator 105. The sentence acquisition unit 101 may acquire a sentence from an input device, such as a keyboard or a speech input device. The sentence acquisition unit 101 may read a sentence from a storage medium, such as a memory, a magnetic disc, or an optical disc.

With respect to the sentence received from the sentence acquisition unit 101, the alternative expression determination unit 102 determines an expression to be changed to another expression of an identical concept under the intention of the sentence, and supplies the processing result to the rewording task presentation unit 103 and the expression pair generator 105. In the following, the expression determined by the alternative expression determination unit 102 may be referred to as a rewording target expression. The processing performed by the alternative expression determination unit 102 will be mentioned later.

Based on the processing result received from the alternative expression determination unit 102, the rewording task presentation unit 103 generates a rewording task and presents it. The rewording task is an instruction requesting that a rewording target expression be changed to another expression of the identical concept under the intention of the sentence. The rewording task presentation unit 103 outputs the rewording task to, for example, a display device (not shown). The rewording task presentation unit 103 may receive an intention of the sentence in addition to the sentence from the sentence acquisition unit 101. Alternatively, the rewording task presentation unit 103 may presume the intention of the sentence, using an intention presumption model prepared beforehand.

The expression acquisition unit 104 acquires an expression entered in response to the rewording task and supplies the expression to the expression pair generator 105. The expression acquisition unit 104 may acquire an entered expression from an input device, such as a keyboard or a speech input device. In the following, an expression acquired by the expression acquisition unit 104 may be referred to as an input expression.

The expression pair generator 105 generates an expression pair on the basis of the sentence intention received from the sentence acquisition unit 101, the expression received from the alternative expression determination unit 102 (the rewording target expression) and the expression received from the expression acquisition unit 104 (the input expression), and supplies the expression pair to the expression pair combination unit 106. The processing performed by the expression pair generator 105 will be mentioned later.

With respect to a plurality of expression pairs generated by the expression pair generator 105, the expression pair combination unit 106 combines expression pairs which share the intention and part of expressions included in the expression pairs (one of the paired expressions), thereby generating a concept set. The concept set, thus generated, is supplied to the concept set registration unit 107 together with the intention. The processing performed by the expression pair combination unit 106 will be mentioned later.

The expression pair generator 105 and the expression pair combination unit 106 are examples of the elements that form a concept set generator 109. The method of generating the concept set is not limited to the method described in relation to the present embodiment. For example, the concept set generator 109 may generate a concept set on the basis of the intention of a sentence, a rewording target expression and an input expression, without generating expression pairs.

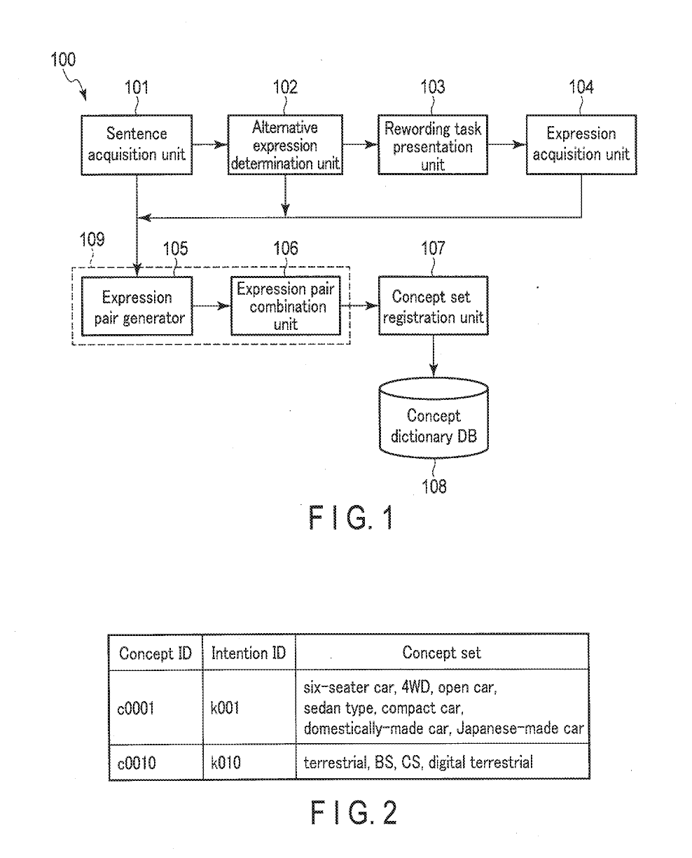

The concept set registration unit 107 registers, in the concept dictionary database 108, the concept set received from the expression pair combination unit 106 and the intention in association with each other. FIG. 2 shows an example of information stored in the concept dictionary database 108. The concept dictionary database 108 may include three fields “concept ID”, “intention ID” and “concept set”, as shown in FIG. 2. In the field of “concept ID”, a unique ID (identification information) is described. In the field of “intention ID”, an ID for identifying an intention is described. In the field of “intention ID”, a plurality of IDs can be described, with a comma inserted therebetween. In the field of “concept set”, a plurality of expressions that can be regarded as being of the identical concept under the intention specified by the intention ID are described, with a comma inserted therebetween. For example, in the first row, the concept ID is “c0001”, the intention ID is “k001”, and the concept set is “six-seater car, 4WD, open car, sedan type, compact car, domestically-made car, Japanese-made car.”

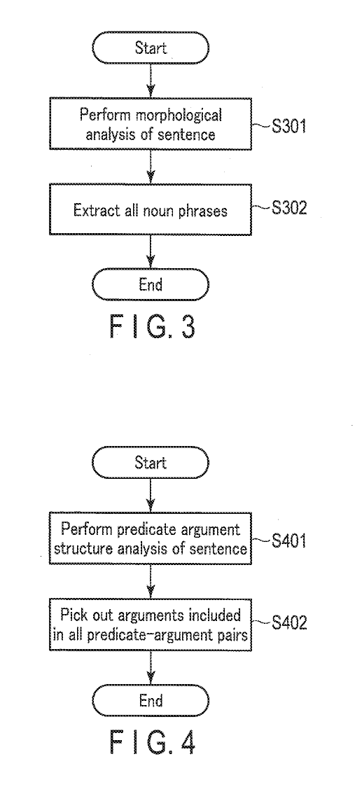

FIG. 3 illustrates an example of processing performed by the alternative expression determination unit 102. In step S301 shown in FIG. 3, the alternative expression determination unit 102 performs morphological analysis with respect to a sentence acquired by the sentence acquisition unit 101. Since the morphological analysis is well known in the art, an explanation of this analysis will be omitted. In step S302, the alternative expression determination unit 102 extracts all noun phrases as reworded expressions from the result of the morphological analysis. In this example, all noun phrases are extracted from a sentence. Instead of the noun phrases, other parts of the sentence may be used. For example, the alternative expression determination unit 102 may extract verb phrases, adjective phrases or adverb phrases.

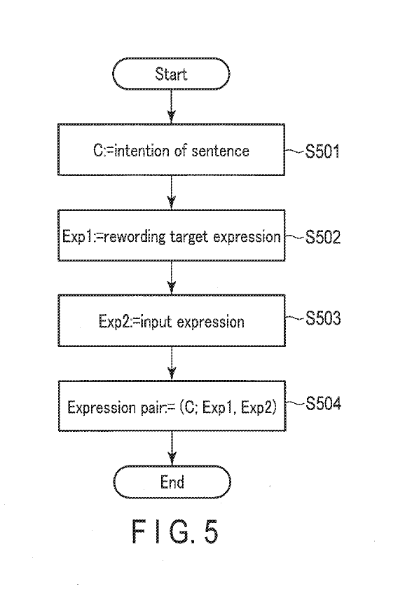

FIG. 4 illustrates another example of processing performed by the alternative expression determination unit 102. In step S401 shown in FIG. 4, the alternative expression determination unit 102 performs predicate argument structure analysis with respect to a sentence acquired by the sentence acquisition unit 101. The predicate argument structure analysis is processing of determining a term (for example, a noun phrase) corresponding to an argument of each predicate in the sentence. Since the processing is well known in the art, an explanation of this processing will be omitted. In step S402, the alternative expression determination unit 102 extracts all predicates and their arguments from the result of the predicate argument structure analysis, and picks out all the arguments of the predicates as reworded expressions. In this example, all noun phrases that are the arguments of the predicates are extracted from the sentence. The processing shown in FIG. 4 differs from the processing shown in FIG. 3 in that noun phrases which are important in a sentence construction are extracted. Predicates themselves may be extracted instead of the arguments of the predicates.

Where a plurality of rewording target expressions are acquired, the rewording task presentation unit 103 may generate a plurality of rewording tasks corresponding to the respective rewording target expressions.

Alternatively, the rewording task presentation unit 103 may generate a single rewording task, using all rewording target expressions.

FIG. 5 illustrates an example of processing performed by the expression pair generator 105. In step S501 shown in FIG. 5, the expression pair generator 105 sets an intention of a sentence received from the sentence acquisition unit 101 as variable C. The expression pair generator 105 may receive the intention of the sentence along with the sentence from the sentence acquisition unit 101. Alternatively, the expression pair generator 105 may presume the intention of the received sentence, using an intention presumption model prepared beforehand.

In step S502, the expression pair generator 105 sets a rewording target expression received from the alternative expression determination unit 102 (namely, an expression to be changed into another expression) as variable Exp1. In step S503, the expression pair generator 105 sets an input expression received from the expression acquisition unit 104 (namely, an expression entered after the rewording task is presented) as variable Exp2. In step S504, the expression pair generator 105 sets (C; Exp1, Exp2) as an expression pair and ends the processing.

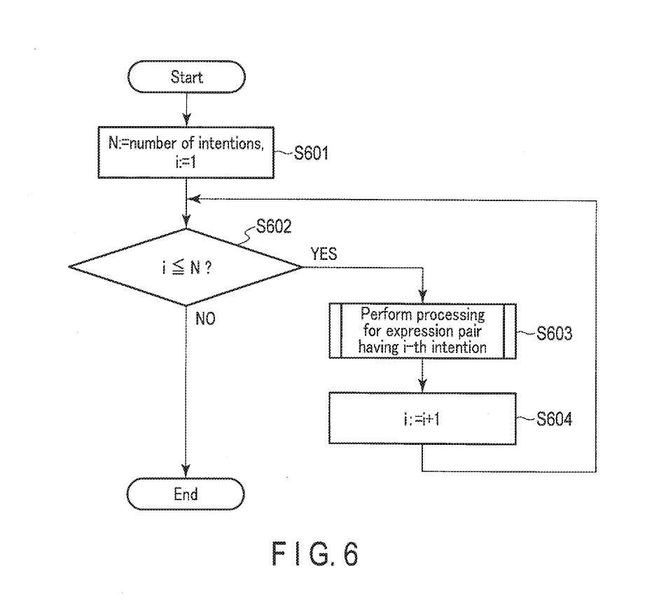

Processing performed by the expression pair combination unit 106 will be described with reference to FIGS. 6, 7 and 8.

FIG. 6 illustrates an example of processing performed by the expression pair combination unit 106. In step S601 shown in FIG. 6, the expression pair combination unit 106 extracts different intentions from a plurality of expression pairs generated by the expression pair generator 105, and sets the number of extracted intentions as variable N. In addition, the expression pair combination unit 106 sets initial value “1” as variable i. In step S602, the expression pair combination unit 106 determines whether variable i is not more than N. If variable i is not more than N, the processing proceeds to step S603. If variable i is more than N, the processing is ended.

If the processing proceeds to step S603, the expression pair combination unit 106 performs processing for the expression pair having the i-th intention (step S603). Specific processing performed in step S603 will be described later. In step S604, the expression pair combination unit 106 increments variable i by one, and the processing returns to step S602.

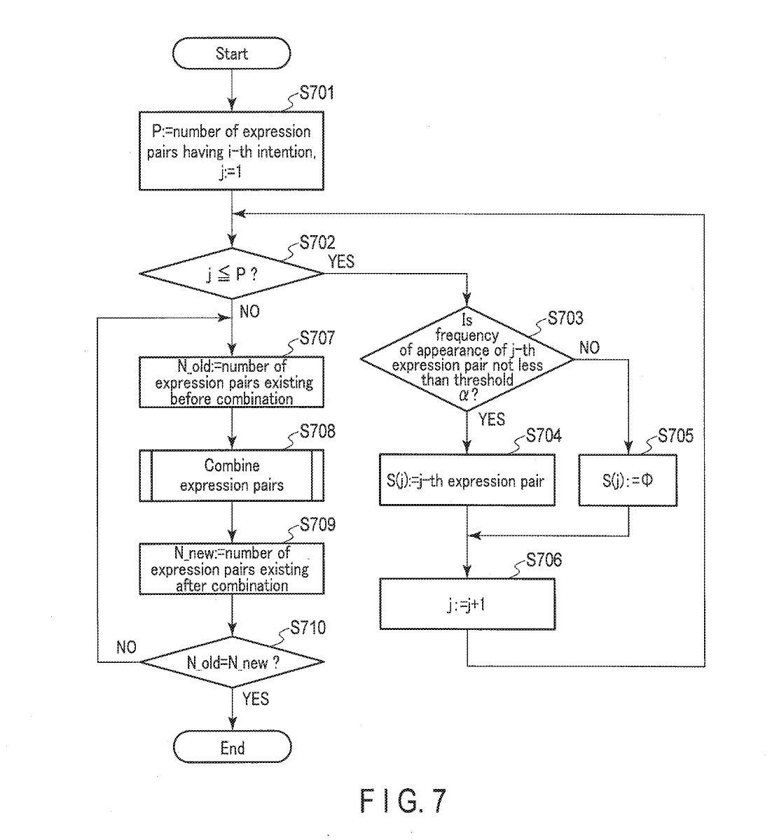

FIG. 7 illustrates an example of processing performed in step S603. In step S701 shown in FIG. 7, the expression pair combination unit 106 sets, as variable P, the number of mutually-different expression pairs having the i-th intention. In addition, the expression pair combination unit 106 sets initial value “1” as variable j. In step S702, the expression pair combination unit 106 determines whether variable j is not more than P. If variable j is not more than P, the processing proceeds to step S708. If variable j is more than P, the processing proceeds to step S707.

If the processing proceeds to step S703, the expression pair combination unit 106 determines whether the frequency of appearance of the j-th expression pair is not less than predetermined threshold α (step S703). The frequency of appearance indicates the number of expression pairs that are identical or redundant. For example, if there is no expression pair identical to the j-th expression pair, the frequency of appearance is 1. If there is one expression pair identical to the j-th expression pair, the frequency of appearance is 2. If the frequency of appearance is not less than α, the processing proceeds to step S704. If the frequency of appearance is less than α, the processing proceeds to step S705. Assuming that threshold α is 2, the expression pair that appears only once is discarded, so that the inclusion of an outlier is prevented.

Threshold α may be set at 1. In this case, the processing never fails to proceed to step S704. In other words, the processing in step S703 and the processing in step S705 may be deleted.

If the processing proceeds to step S704, the expression pair combination unit 106 sets the j-th expression pair as variable S(j) (step S704). If the processing proceeds to step S705, the expression pair combination unit 106 sets a null set as variable S(j), that is, variable S(j) is emptied (step S705).

In step S706, the expression pair combination unit 106 increments variable j by one, and the processing returns to step S702.

If the processing proceeds from step S702 to step S707, the expression pair combination unit 106 sets the number of expression pairs existing before the combination processing (namely, the number of variables S(j)) as variable N_old (step S707). When the number of expression pairs is counted, the expression pairs of the null set are not counted. In step S708, the expression pair combination unit 106 performs combination processing for the expression pairs. The processing performed in step S708 will be described later. In step S709, the expression pair combination unit 106 sets the number of expression pairs existing after the combination processing as variable N_new. In step S710, the expression pair combination unit 106 determines whether N_old and N_new are equal to each other. If N_old and N_new are equal to each other, the processing is ended. If they are not, the processing returns to step S707, and the combination processing for expression pairs is repeated.

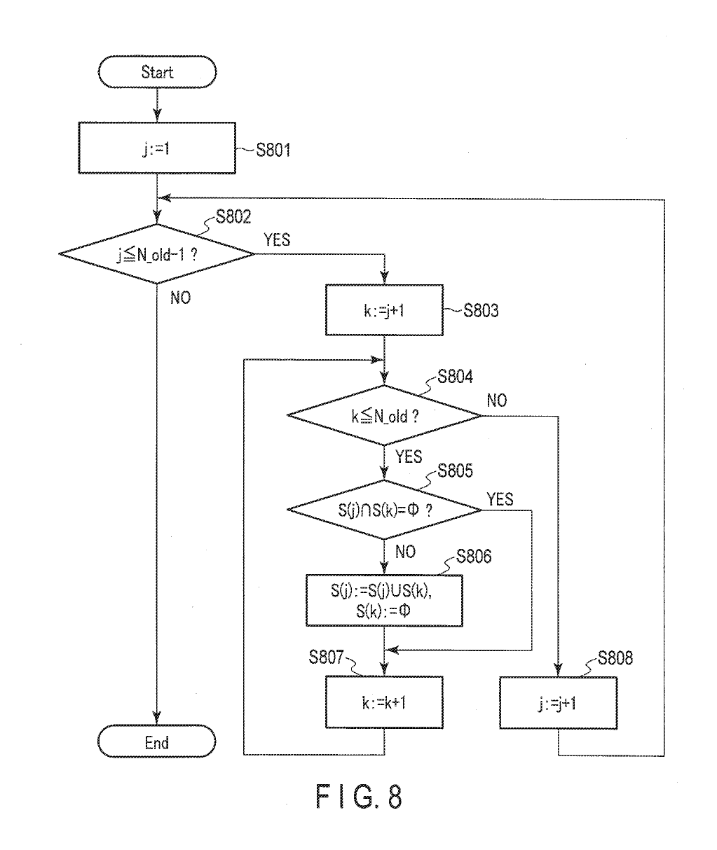

FIG. 8 illustrates an example of expression pair combination processing performed in step S708. In step S801 shown in FIG. 8, the expression pair combination unit 106 sets initial value “1” as variable j. In step S802, the expression pair combination unit 106 determines whether variable j is not more than (N_old−1). If variable j is not more than (N_old−1), the processing proceeds to step S803. If variable j is more than (N_old−1), the processing is ended, and variable S other than a null set is supplied to the concept set registration unit 107 as a concept set.

If the processing proceeds to step S803, the expression pair combination unit 106 sets (j+1) as variable k (step S803). In step S804, the expression pair combination unit 106 determines whether variable k is not more than N_old. If variable k is not more than N_old, the processing proceeds to step S805. If variable k is more than P, the processing proceeds to step S807.

If the processing proceeds to step S805, the expression pair combination unit 106 determines whether the intersection of variable S(j) and variable S(k) is a null set (step S805). If the intersection is not a null set, the processing proceeds to step S806. If the intersection is a null set, the processing proceeds to step S807.

If the processing proceeds to step S806, the expression pair combination unit 106 sets the union of variables S(j) and S(k) as variable S(j) (step S806). In addition, the expression pair combination unit 106 sets a null set as variable S(k), that is, variable S(k) is emptied. In step S807, the expression pair combination unit 106 increments variable k by one, and the processing returns to step S804.

If the processing proceeds from step S804 to step S808, the expression pair combination unit 106 increments variable j by one (step S808), and the processing returns to step S802.

In the processing performed in step S805, whether or not to update variable S(j) is determined by checking whether the intersection of variable S(j) and variable S(k) is a null set. Instead of this, the expression pair combination unit 106 may determine whether variable S(j) should be updated, by generating a group of synonyms of variable S(j) and a group of synonyms of variable S(k) by use of a thesaurus, and determining whether the intersection of the group of synonyms of variable S(j) and the group of synonyms of variable S(k) is a null set. In this case, expression pairs that do not include an expression common to them may be combined. In this way, expression pairs can be combined in a wider range.

The expression pair combination unit 106 may use a thesaurus and acquire synonymous expressions of an expression included in an expression pair. Based on this, the expression pair combination unit 106 may combine expression pairs which share the same sentence intention and the same synonymous expressions.

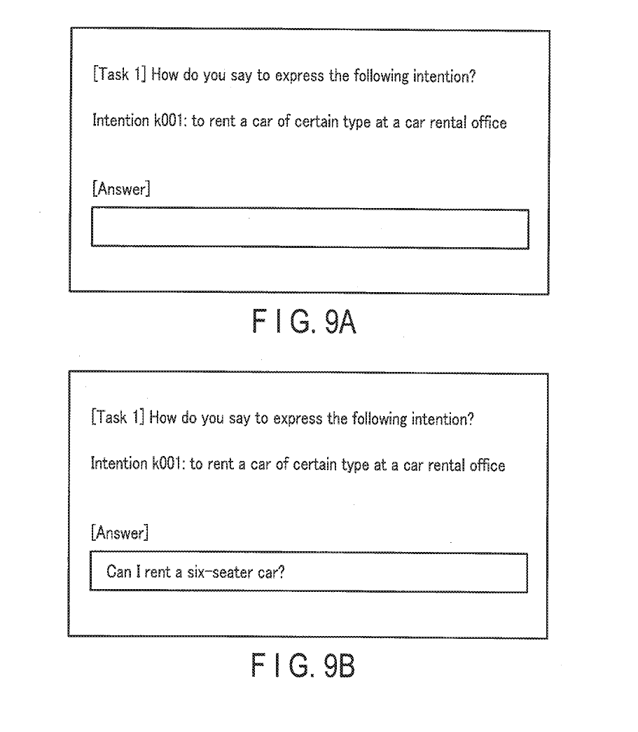

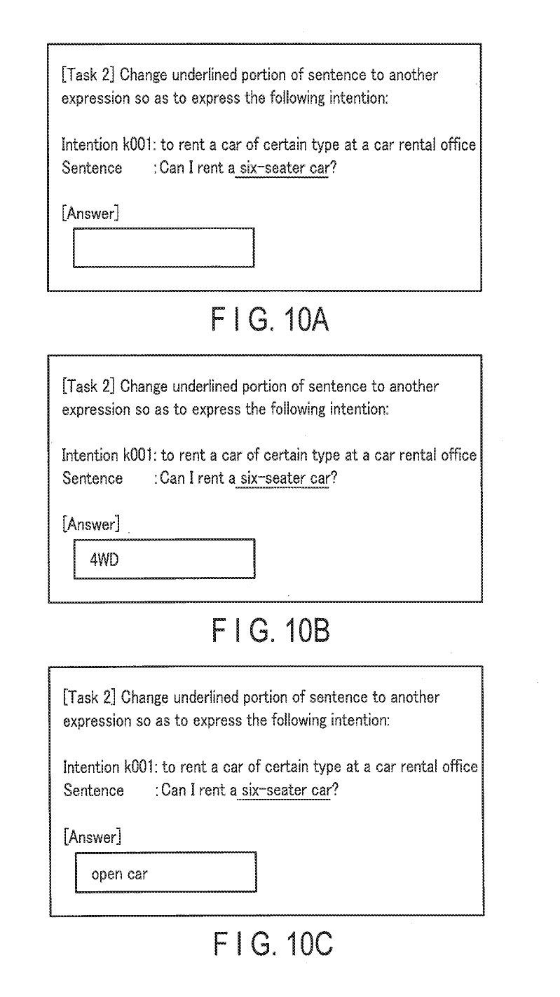

A specific example of an operation performed by the concept dictionary creation apparatus 100 will be described with reference to FIGS. 9A and 9B and FIGS. 10A to 10C.

As shown in FIG. 9A, the concept dictionary creation apparatus 100 causes a display to show a task that requests the creation of a sentence reflecting an intention. The task is displayed, for example, by the rewording task presentation unit 103. In the example shown in FIG. 9A, the concept dictionary creation apparatus 100 presents the task: “How do you say to express the intention to rent a car of certain type at a car rental office”, and prompts the operator to enter a sentence. In FIG. 9A, ID “k001” is attached to the intention “to rent a car of certain type at a car rental office.” This ID need not be indicated on the display.

Let us assume that the operator enters the sentence “Can I rent a six-seater car?”, as shown in FIG. 9B. The sentence acquisition unit 101 receives the entered sentence and supplies it to the alternative expression determination unit 102. The alternative expression determination unit 102 performs predicate argument structure analysis with respect to the received sentence to extract an argument of a predicate. The predicate argument structure analysis performed for the sentence “Can I rent a six-seater car?” yields the following analysis result:

Predicate: rent

Object: six-seater car

As the argument of the predicate “rent”, “six-seater car” is extracted. In this example, the argument corresponds to the object of the predicate.

In response to the processing result, the rewording task presentation unit 103 presents a rewording task, such as that shown in FIG. 10A. For example, the rewording task presentation unit 103 presents the rewording task “Change the underlined portion of the sentence to another expression so as to express the intention to rent a car of certain type at a car rental office.” The rewording task presentation unit 103 further presents the sentence “Can I rent a six-seater car?”

Let us assume that an operator answers “4WD”, as shown in FIG. 10B, and another operator answers “open car”, as shown in FIG. 10C, and that other operators answer “sedan type”, “compact car”, “domestically-made car”, and “Japanese-made car.”

In response to these inputs, the expression pair generator 105 generates the following expression pairs:

(k001; six-seater car, 4WD)

(k001; six-seater car, open car)

(k001; six-seater car, sedan type)

(k001; six-seater car, open car)

(k001; six-seater car, domestically-made car)

(k001; six-seater car, Japanese-made car)

In response, the expression pair combination unit 106 sequentially combines expression pairs, provided that the frequencies of appearance of the expression pairs are equal to α or more and that the expression pairs share a partial expression. It is assumed here that α=1. Since, in this case, all expression pairs share the expression “six-seater car”, the following concept set is generated:

(k001; six-seater car, 4WD, open car, sedan type, compact car, domestically-made car, Japanese-made car)

The concept set registration unit 107 automatically allocates a concept ID to the concept set received from the expression pair combination unit 106, and stores the concept set in the concept dictionary database 108. As a result, information such as that shown in the first row of the database 108 in FIG. 2 is stored.

The concept set includes words broader than generally-accepted synonyms, but these words can be regarded as being of the identical concept under the intention to “rent a car of certain type at a car rental office.” Since the concept set registration unit automatically generates concept IDs, it is not necessary to design a concept system beforehand, and the expressions that can be regarded as being of the identical concept under a certain intention can be generalized by a concept ID.

As described above, the concept dictionary creation apparatus 100 of the present embodiment presents a task requesting that an expression included in a sentence be changed to another expression which is of the identical concept under the intention of the sentence, acquires expressions entered in response to the task, and generates a concept set on the basis of the intention of the sentence, the expressions included in the sentence and the entered expressions. In this manner, a concept set can be generated including expressions which can be regarded as being of the identical concept under a certain intention.

### Second Embodiment

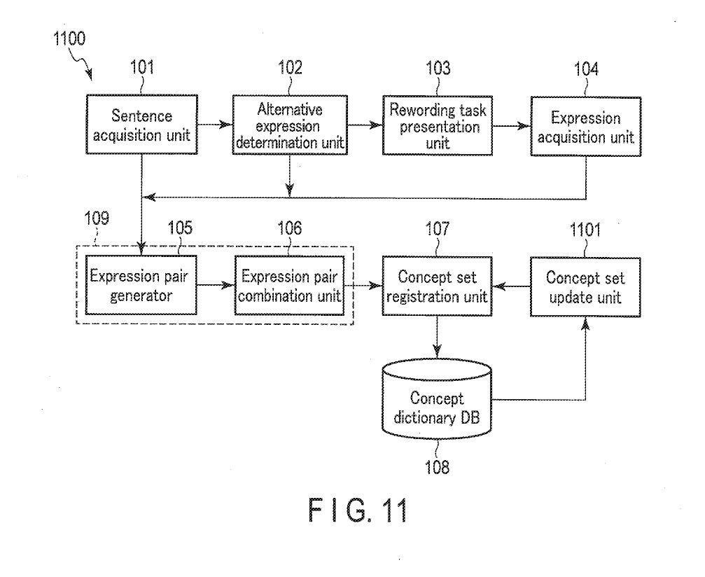

FIG. 11 schematically illustrates a concept dictionary creation apparatus 1100 according to the second embodiment. As shown in FIG. 11, the concept dictionary creation apparatus 1100 comprises a sentence acquisition unit 101, an alternative expression determination unit 102, a rewording task presentation unit 103, an expression acquisition unit 104, an expression pair generator 105, an expression pair combination unit 106, a concept set registration unit 107, a concept dictionary database 108 and a concept set update unit 1101. The concept dictionary creation apparatus 1100 is similar to the concept dictionary creation apparatus 100 shown in FIG. 1, except that the concept set update unit 1101 is added. The concept dictionary creation apparatus 1100 has a function of automatically updating the concept dictionary database 108. In connection with the second embodiment, a description will be given as to how the concept dictionary database 108 is updated, and a description of the other operations will be omitted.

The concept set update unit 1101 updates the concept sets stored in the concept dictionary database 108. To be more specific, the concept set update unit 1101 receives data from the concept dictionary database 108, calculates a degree of similarity between concept sets, and creates a new concept set by combining those concept sets which have a high degree of similarity.

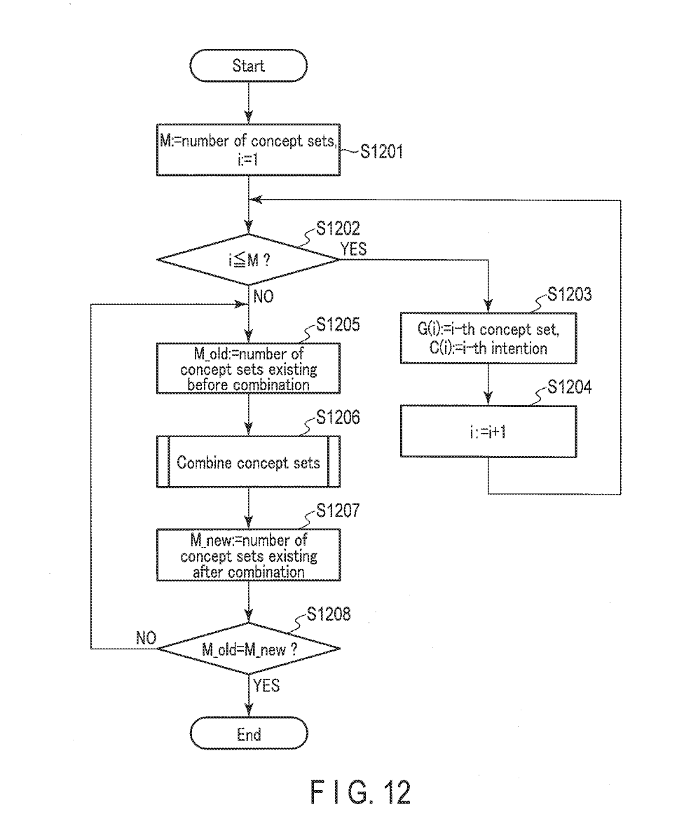

FIG. 12 illustrates an example of processing performed by the concept set update unit 1101. In step S1201 shown in FIG. 12, the concept set update unit 1101 sets the number of concept sets stored in the concept dictionary database 108 as variable M, and further sets initial value “1” as variable i. In step S1202, the concept set update unit 1101 determines whether variable i is not more than M. If variable i is not more than M, the processing proceeds to step S1203. If variable i is more than M, the processing proceeds to step S1205.

If the processing proceeds step S1203, the concept set update unit 1101 sets the i-th concept set of the concept dictionary database 108 as variable G(i), and further sets the i-th intention of the concept dictionary database 108 as variable C(i) (step S1203). In step S1204, the concept set update unit 1101 increments variable i by one, and the processing returns to step S1202.

If the processing proceeds from step S1202 to step S1205, the concept set update unit 1101 sets the number of concept sets existing before the combination processing (namely, the number of variables G(i)) as variable M_old (step S1205). When the number of concept sets is counted, the concept sets of a null set are not counted. In step S1206, the concept set update unit 1101 performs combination processing for concept sets. The processing performed in step S1206 will be described later. In step S1207, the concept set update unit 1101 sets the number of concept sets existing after the combination processing as variable M_new. In step S1208, the concept set update unit 1101 determines whether M_old is equal to M_new. If M_old is equal to M_new, the processing is ended. If not, the processing returns to step S1205, and the combination processing for concept sets is repeated.

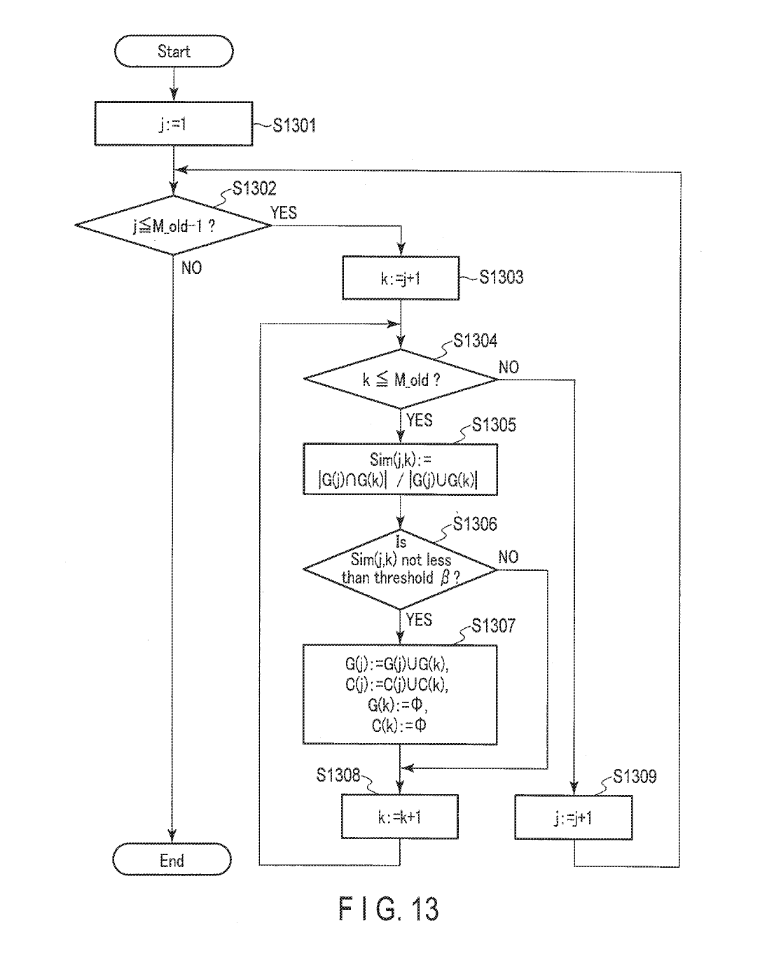

The combination processing for concept sets performed in step S1206 will be described with reference to FIG. 13.

In step S1301 shown in FIG. 13, the concept set update unit 1101 sets initial value “1” as variable j. In step S1302, the concept set update unit 1101 determines whether variable j is not more than (M_old−1). If variable j is not more than (M_old−1), the processing proceeds to step S1303. If variable j is more than (M_old−1), the processing is ended.

If the processing proceeds to step S1303, the concept set update unit 1101 sets (j+1) as variable k (step S1303). In step S1304, the concept set update unit 1101 determines whether variable k is not more than (M_old−1). If variable k is not more than (M_old−1), the processing proceeds to step S1305. If variable k is more than (M_old−1), the processing proceeds to step S1309.

If the processing proceeds to step S1305, the concept set update unit 1101 calculates a degree of similarity Sim(j,k) between variable G(j) and variable G(k) according to the formula below (step S1305).

Sim(j,k)=|G(j)∩G(k)|/|G(j)∪G(k)|

where |G(j)∩G(k)| denotes the number of expressions included in the intersection of G(j) and G(k), and |G(j)∪G(k)| denotes the number of expressions included in the union of G(j) and G(k).

In step S1306, the concept set update unit 1101 determines whether Sim(j,k) is not less than predetermined threshold β. If Sim(j,k) is not less than β, the processing proceeds to step S1307. If Sim(j,k) is less than β, the processing proceeds to step S1308.

If the processing proceeds to step S1307, the concept set update unit 1101 sets the union of G(j) and g(k) as variable G(j), and sets the union of C(j) and C(k) as variable C(j) (step S1307). In addition, the concept set update unit 1101 sets null sets as variable G(k) and variable C(k), that is, variable G(k) and variable C(k) are emptied. In step S1308, the concept set update unit 1101 increments variable k by one, and the processing returns to step S1304.

If the processing proceeds from step S1304 to step S1309, the concept set update unit 1101 increments variable j by one (step S1309), and the processing returns to step S1302.

As described above, the concept dictionary creation apparatus 1100 of the present embodiment calculates a degree of similarity between the concept sets included in the concept dictionary database 108 and combines those concept sets whose degree of similarity is more than a threshold. As a result, a concept set including a larger number of expressions can be generated.

### Third Embodiment

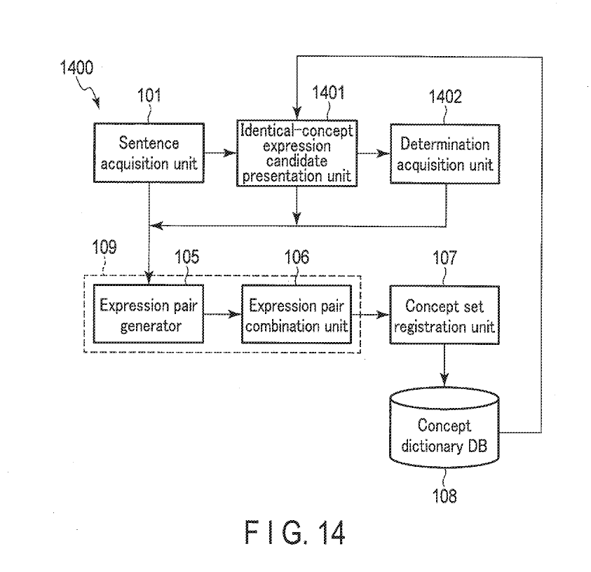

FIG. 14 schematically illustrates a concept dictionary creation apparatus 1400 according to the third embodiment. The present embodiment is useful when a concept dictionary database is updated based on human judgment. As shown in FIG. 14, the concept dictionary creation apparatus 1400 comprises a sentence acquisition unit 101, an identical-concept expression candidate presentation unit 1401, a determination acquisition unit 1402, an expression pair generator 105, an expression pair combination unit 106, a concept set registration unit 107 and a concept dictionary database 108. The sentence acquisition unit 101, expression pair combination unit 106 and concept dictionary database 108 perform operations similar to those mentioned in connection with the first embodiment. Therefore, a description of the sentence acquisition unit 101, expression pair combination unit 106 and concept dictionary database 108 will be omitted.

The identical-concept expression candidate presentation unit 1401 refers to the concept dictionary database 108 to generate candidate expressions of an identical concept for part of a sentence received from the sentence acquisition unit 101, and presents the candidate expressions as identical-concept expression candidates together with the intention of the sentence. The processing performed by the identical-concept expression candidate presentation unit 1401 will be mentioned later.

The determination acquisition unit 1402 acquires determinations as to whether or not an expression in a sentence and a presented identical-concept expression candidate are of the identical concept under a presented intention. The determinations may be acquired from an input device, such as a keyboard and a speech input device, and are supplied to the expression pair generator 105.

The expression pair generator 105 generates an expression pair on the basis of the determinations received from the determination acquisition unit 1402. To be more specific, where a determination shows that an expression included in a sentence and a presented identical-concept expression candidate are of the identical concept under a presented intention, the expression pair generator 105 generates an expression pair on the basis of the intention of the sentence received from the sentence acquisition unit 101, the expression in the sentence and the identical-concept expression candidate. The processing performed by the expression pair generator 105 of the present embodiment differs somewhat from the processing shown in FIG. 5, and will be described later.

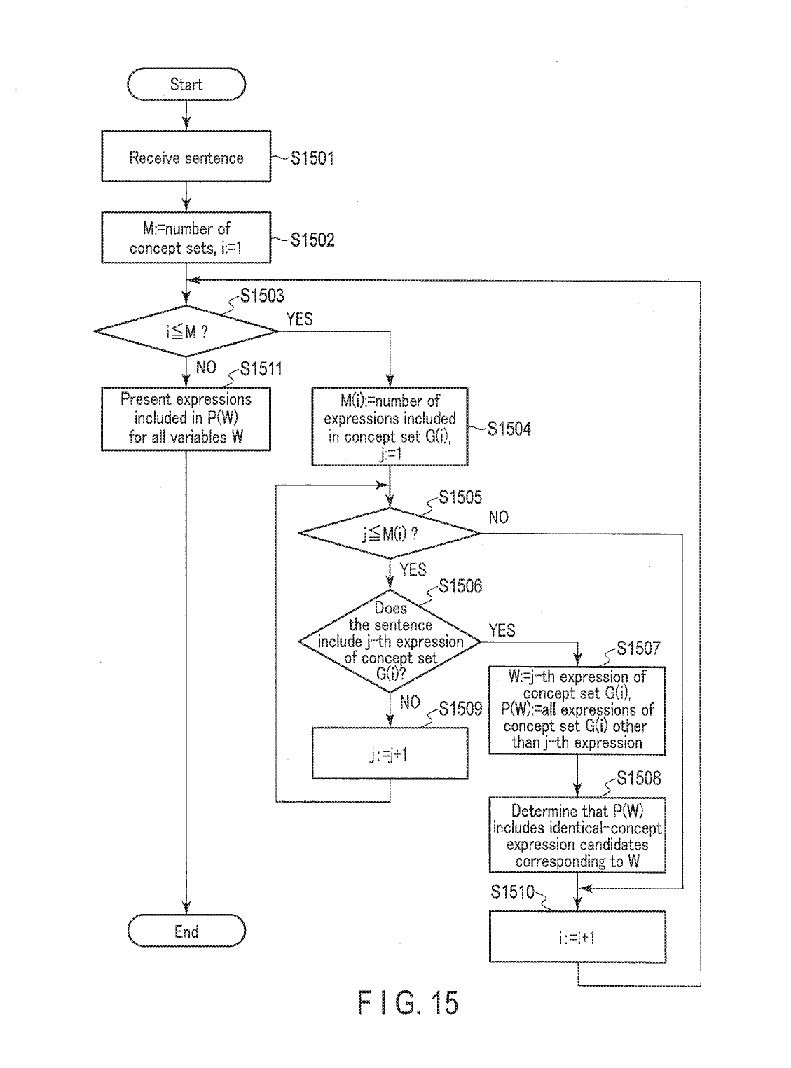

FIG. 15 illustrates an example of processing performed by the identical-concept expression candidate presentation unit 1401. In step S1501 shown in FIG. 15, the identical-concept expression candidate presentation unit 1401 receives a sentence from the sentence acquisition unit 101. In step S1502, the identical-concept expression candidate presentation unit 1401 sets the number of concept sets stored in the concept dictionary database 108 as variable M, and further sets initial value “1” as variable i.

In step S1503, the identical-concept expression candidate presentation unit 1401 determines whether variable i is not more than M. If variable i is not more than M, the processing proceeds to step S1504. If variable i is more than M, the processing proceeds to step S1511.

If the processing proceeds to step S1504, the identical-concept expression candidate presentation unit 1401 sets the number of expressions included in the i-th concept set of the concept dictionary database 108 as variable M(i), and further sets initial value “1” as variable j (step S1504).

In step S1505, the identical-concept expression candidate presentation unit 1401 determines whether variable j is not more than M(i). If variable j is not more than M, the processing proceeds to step S1506. If variable i is more than M, the processing proceeds to step S1510.

If the processing proceeds to step S1506, the identical-concept expression candidate presentation unit 1401 determines whether the sentence includes the j-th expression of the concept set G(i) (step S1506). If the sentence includes the j-th expression of the concept set G(i), the processing proceeds to step S1507. If not, the processing proceeds to step S1509.

If the processing proceeds to step S1507, the identical-concept expression candidate presentation unit 1401 sets the j-th expression of the concept set G(i) as variable W, and further sets all expressions of the concept set G(i) other than the j-th expression as variable P(W) (step S1507). In step S1508, the identical-concept expression candidate presentation unit 1401 determines that P(W) includes identical-concept expression candidates corresponding to W.

If the processing proceeds from step S1506 to step S1509, the identical-concept expression candidate presentation unit 1401 increments variable j by one (step S1509), and the processing returns to step S1505.

If the processing proceeds from step S1508 or step S1505 to step S1510, the identical-concept expression candidate presentation unit 1401 increments variable i by one (step S1510), and the processing returns to step S1503.

If the processing proceeds from step S1503 to step S1511, the identical-concept expression candidate presentation unit 1401 presents expressions included in P(W) for all variables W (step S1511), and ends the processing.

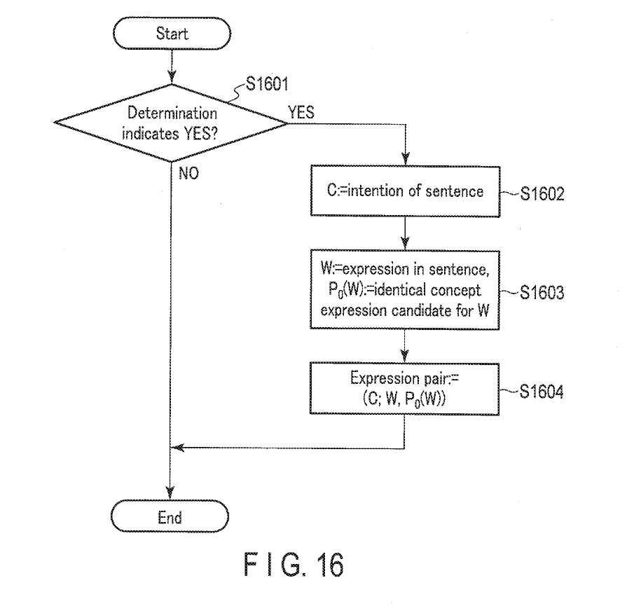

FIG. 16 illustrates an example of processing performed by the expression pair generator 105 of the present embodiment. In step S1601 shown in FIG. 16, the expression pair generator 105 receives a determination from the determination acquisition unit 1402 and checks whether the determination indicates “YES.” If the determination indicates “YES”, the processing proceeds to step S1602. If not, the processing is ended.

If the processing proceeds to step S1602, the expression pair generator 105 sets an intention of the sentence received from the sentence acquisition unit 101 as variable C (step S1602). In step S1603, the expression pair generator 105 sets the expression in the sentences received from the identical-concept expression candidate presentation unit 1401 as variable W, and further sets presented identical-concept expression candidate for variable W as variable P₀(W). In step S1604, the expression pair generator 105 determines that (C; W, P₀(W)) is an expression pair, and ends the processing.

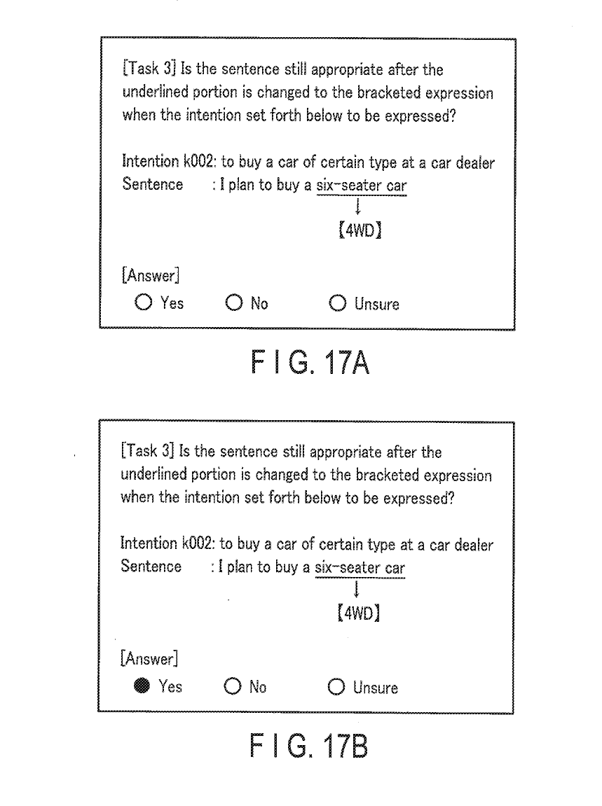

A specific example of an operation performed by the concept dictionary creation apparatus 1400 will be described with reference to FIGS. 17A and 17B.

First, the concept dictionary creation apparatus 1400 causes the display to show a task that requests the creation of a sentence reflecting a designated intention. For example, the concept dictionary creation apparatus 1400 presents the task: “How do you say to express the intention to buy a car of certain type at a car dealer”, and prompts the operator to enter a sentence.

Let us assume that the operator enters the sentence “I plan to buy a six-seater car.” The identical-concept expression candidate presentation unit 1401 refers to the information stored in the concept dictionary database 108 and presents a group of expressions that can be used in place of an expression of the sentence as identical-concept expression candidates. For example, the identical-concept expression candidate presentation unit 1401 decides to present “4WD”, “open car”, “sedan type”, “compact car”, “domestically-made car” and “Japanese-made car” as identical-concept expression candidates corresponding to “six-seater car” included in the sentence “I plan to buy a six-seater car.” As shown in FIG. 17A, the identical-concept expression candidate presentation unit 1401 causes the display to show the following task: “Is the sentence ‘I plan to buy a six-seater car’ still appropriate after “six-seater car” is changed to “4WD” when the intention to “buy a car of certain type at a car dealer” is to be expressed.” The identical-concept expression candidate presentation unit 1401 prompts the operator to choose “Yes”, “No” or “Unsure.” In this example, the ID “k002” is attached to the intention “to buy a car of certain type at a car dealer.” This ID need not be indicated on the display. With respect to the other identical-concept expression candidates, similar tasks are presented and the operator is prompted to enter a determination result.

Let us assume that the operator chooses “Yes”, as shown in FIG. 17B. The determination acquisition unit 1402 receives the determination result and supplies it to the expression pair generator 105. Then, “open car”, “sedan type”, “compact car”, “domestically-made car” and “Japanese-made car” are sequentially presented. It is assumed here that the operator chooses “Yes” in response to the presentations “open car”, “sedan type” and “compact car.” In this case, the expression pair generator 105 generates the following four expression pairs:

(k002; six-seater car, 4WD)

(k002; six-seater car, open car)

(k002; six-seater car, sedan type)

(k002; six-seater car, compact car)

With respect to these expression pairs, the expression pair combination unit 106 checks the frequency of appearance and combines the expression pairs if their frequency of appearance is α or more. It is assumed here that α=1. Since, in this case, all expression pairs share the expression “six-seater car”, the following concept set is generated:

(k002; six-seater car, 4WD, open car, sedan type, compact car)

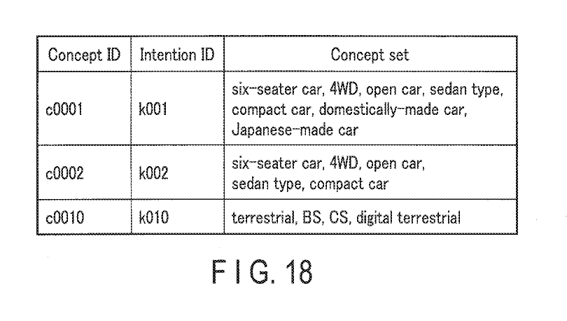

The concept set registration unit 107 automatically allocates a concept ID to the generated concept set and stores the concept set in the concept dictionary database 108. As a result, information such as that shown in the second row of the database 108 in FIG. 18 is added.

As described above, the concept dictionary creation apparatus 1400 of the present embodiment presents, as identical-concept expression candidates, expressions which can be regarded as being of the identical concept as an expression of an input sentence under the intention of the sentence, and generates concept sets from the expression, the identical-concept expression candidate and the intention, in accordance with determinations of whether the identical-concept expression candidates are of the identical concept as the expression in the sentence. In this manner, a concept set can be generated including expressions which can be regarded as being of the identical concept under a certain intention.

The instructions included in the steps described in the foregoing embodiments may be implemented based on a software program. A general-purpose computer system may store the program beforehand and read the program in order to attain the same advantage as the above-described concept dictionary creation apparatuses. The instructions described in the above embodiments are stored in a magnetic disc (flexible disc, hard disc, etc.), an optical disc (CD-ROM, CD-R, CD-RW, DVD-ROM, DVD±R, DVD±RW, Blu-ray disc, etc.), a semiconductor memory, or a similar storage medium, as a program executable by a computer. As long as the storage medium is readable by a computer or by an embedded system, any storage format can be used. An operation similar to the operation of the concept dictionary creation apparatus of each of the above-described embodiments can be realized, if a computer reads a program from the storage medium and executes the instructions described in the program on the CPU on the basis of the program. Needless to say, the computer may acquire or read the program by way of a network.

Furthermore, an operating system (OS) working on a computer on the basis of instructions of a program read from a storage medium and installed in a computer or an embedded system, database management software, middleware (MW) of a network, etc. may execute part of the processing for realizing the embodiments.

Moreover, a storage medium employed in each of the embodiments is not limited to a medium provided independently of a system or a built-in system; a storage medium storing or temporarily storing a program downloaded through a LAN, the Internet, etc. is also employed in each of the embodiments.

In addition, the storage medium employed in each of the embodiments is not limited to a single storage medium. Multiple storage mediums may be employed to execute the processes of each of the embodiments. The storage medium or mediums may be of any configuration.

The computer or built-in system of each of the embodiments is used to execute the processes of the embodiments on the basis of a program stored in the storage medium, and may be an apparatus consisting of a PC, a microcomputer or the like or a system in which multiple apparatuses are connected through a network.

The computer referred to in each of the embodiments is not limited to a PC; it may be a processor, a controller, a microcomputer, etc. included in an information processor. The computer used herein is a general term covering a device and an apparatus that can realize the functions of each embodiment by executing a program.

While certain embodiments have been described, these embodiments have been presented by way of example only, and are not intended to limit the scope. Indeed, the novel embodiments described herein may be embodied in a variety of other forms; furthermore, various omissions, substitutions and changes in the form of the embodiments described herein may be made without departing from the spirit. The accompanying claims and their equivalents are intended to cover such forms or modifications as would fall within the scope and spirit.

What is claimed is:

1. A concept dictionary creation apparatus comprising:
a task presentation unit which presents a task requesting that a first expression included in a sentence be changed to another expression of an identical concept under an intention of the sentence;
an expression acquisition unit which acquires a second expression entered in response to the task; and
a concept set generator which generates a concept set based on the intention, the first expression and the second expression.

2. The apparatus according to claim 1, wherein the concept set generator comprises:
an expression pair generator which generates an expression pair including the intention, the first expression and the second expression; and
an expression pair combination unit which generates a concept set by combining expression pairs which are generated by the expression pair generator and which share the intention and part of expressions included in the expression pairs.

3. The apparatus according to claim 2, wherein the expression pair combination unit combines expression pairs which are generated by the expression pair generator, which share the intention and part of expressions included in the expression pairs, and which have a frequency of appearance more than a first threshold.

4. The apparatus according to claim 2, wherein the expression pair combination unit acquires, for each of expression pairs generated by the expression pair generator, a synonymous expression which is synonymous with any of expressions included in the expression pair, using a thesaurus, and combines expression pairs which share the synonymous expression.

5. The apparatus according to claim 1, further comprising:
a sentence acquisition unit which acquires the sentence; and
an alternative expression determination unit which extracts from the acquired sentence an expression to be changed to another expression of an identical concept under the intention of the sentence, and uses the expression to be changed to another expression as the first expression.

6. The apparatus according to claim 5, wherein the alternative expression determination unit performs morphological analysis for the acquired sentence and selects one of a noun phrase, a verb phrase, an adjective phrase and an adverb phrase as the first sentence.

7. The apparatus according to claim 5, wherein the alternative expression determination unit performs predicate argument structure analysis for the acquired sentence to specify an argument of a predicate, and uses the argument as the first sentence.

8. The apparatus according to claim 5, wherein the alternative expression determination unit performs predicate argument structure analysis for the acquired sentence to specify a predicate and uses the predicate as the first expression.

9. The apparatus according to claim 1, further comprising:
a concept set registration unit which registers the concept set in a concept dictionary database in association with the intention.

10. The apparatus according to claim 9, further comprising:
a concept set update unit which calculates a degree of similarity between concept sets with respect to concept sets stored in the concept dictionary database based on a number of common expressions and a number of different expressions, and which combines concept sets whose degree of similarity is not less than a second threshold, thereby updating the concept dictionary database.

11. A concept dictionary creation apparatus comprising:
a concept dictionary database which stores concept sets;
an identical-concept expression candidate presentation unit which generates an identical-concept expression candidate from concept sets stored in the concept dictionary database and including an expression included in a sentence, and which presents an intention of the sentence, the expression and the identical-concept expression candidate;
a determination acquisition unit which acquires a determination indicating whether the expression and the identical-concept expression candidate are identical in concept under the intention;
a concept set generator which generates a concept set from the expression, the identical-concept expression candidate and the intention, where the determination indicates that the expression and the identical-concept expression unit are identical in concept under the intention; and
a registration unit which registers the generated concept set in the concept dictionary database.
